(19) United States
(12) Patent Application Publication
(10) Pub. No.: US 2024/0262263 A1
(43) Pub. Date: Aug. 8, 2024

(54) VEHICLE SEAT WITH ZERO GRAVITY POSITION

(71) Applicant: Lear Corporation, Southfield, MI (US)

(72) Inventors: Patrick Faye, Roche La Moliere (FR); Antoine Moulin, Aurec-sur-Loire (FR); Clement Chantre, Roche La Moliere (FR)

(21) Appl. No.: 18/491,343

(22) Filed: Oct. 20, 2023

Related U.S. Application Data
(60) Provisional application No. 63/483,398, filed on Feb. 6, 2023.

(51) Int. Cl. B60N 2/16; B60N 2/02; B60N 2/10

(52) U.S. Cl. CPC B60N 2/1645; B60N 2/02246; B60N 2/10

(57) ABSTRACT

An adjustable vehicle seat transitions from a base position to an elevated position to a highly reclined zero-gravity position. A single motor controls movement through these three positions. Between the base position and the elevated position, an orientation of the vehicle seat changes very little. An eccentric gearing mechanism is proposed to move the seat between the three positions. In one embodiment, a compensator absorbs the planetary motion of the eccentric gearing mechanism such that motion is smoother.

### CROSS-REFERENCE TO RELATED APPLICATIONS

This application claims the benefit of U.S. provisional application Ser. No. 63/483,398 filed Feb. 6, 2023, the disclosure of which is hereby incorporated in its entirety by reference herein.

### BRIEF DESCRIPTION OF THE DRAWINGS

FIGS. 1-3 are side views of an adjustable vehicle seat in a base position, an elevated position, and a reclined position, respectively.

FIGS. 4-6 are side stick frame views of the adjustable vehicle seat of FIGS. 1-3 in the base position, elevation position, and reclined position, respectively.

FIG. 7 is a schematic diagram illustrating an eccentric gearing mechanism.

FIG. 8 is a pictorial view of the adjustable seat.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Except in the examples, or where otherwise expressly indicated, all numerical quantities in this description indicating amounts of material or conditions of reaction and/or use are to be understood as modified by the word “about” in describing the broadest scope of the invention. The term “substantially,” “generally,” or “about” may be used herein and may modify a value or relative characteristic disclosed or claimed. In such instances, “substantially,” “generally,” or “about” may signify that the value or relative characteristic it modifies is within ±0%, 0.1%, 0.5%, 1%, 2%, 3%, 4%, 5% or 10% of the value or relative characteristic. Practice within the numerical limits stated is generally preferred.

It should also be appreciated that integer ranges (e.g., for measurements or dimensions) explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. In the specific examples set forth herein, concentrations, temperature, and reaction conditions (e.g. pressure, pH, flow rates etc.) can be practiced with plus or minus 50 percent of the values indicated rounded to three significant figures. In a refinement, concentrations, temperature, and reaction conditions (e.g., pressure, pH, flow rates, etc.) can be practiced with plus or minus 30 percent of the values indicated rounded to three significant figures of the value provided in the examples. In another refinement, concentrations, temperature, and reaction conditions (e.g., pressure, pH, flow rates, etc.) can be practiced with plus or minus 10 percent of the values indicated rounded to three significant figures of the value provided in the examples.

It is also to be understood that this invention is not limited to the specific embodiments and methods described below, as specific components and/or conditions may of course, vary. Furthermore, the terminology used herein is used only for the purpose of describing particular embodiments of the present invention and is not intended to be limiting in any way.

Vehicle seats must accommodate occupants of a variety of different sizes. Occupants also have different preferences regarding seat orientation. Therefore, it is common for vehicle seats to be adjustable in a variety of ways. For example, a vehicle seat may move vertically, fore and aft, and may be reclined to various degrees. Typically, each of these types of movement require separate actuators. Further, the reclining functionality is commonly accomplished primarily by tilting the seat back relative to the seat cushion with relatively little tilting of the seat cushion.

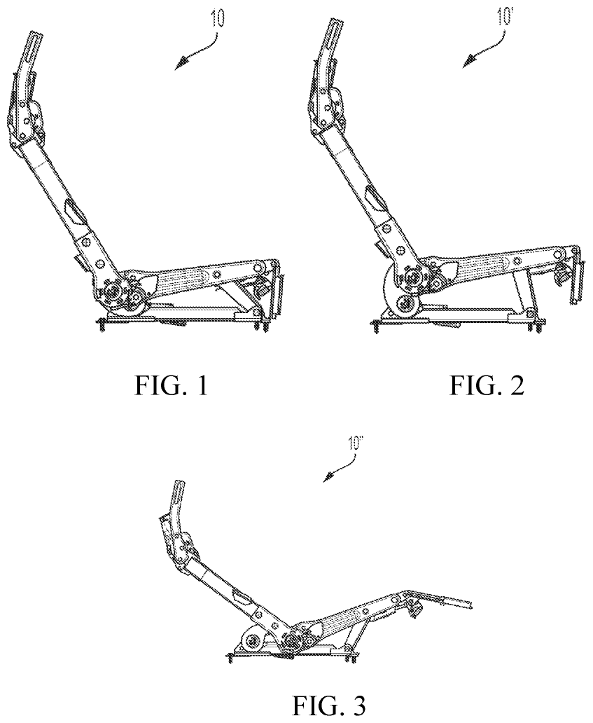

FIGS. 1-3 show an adjustable vehicle seat 10 in three different positions. In FIG. 1, the seat is in a base position. In FIG. 2, the seat is in an elevated position. During movement from the base position to the elevated position, the orientation of the seat cushion is almost constant. The seat cushion moves upward and forward to a position that would be more suitable for a person of shorter stature. The seat back may also remain in the same orientation.

In FIG. 3, the seat is in a highly reclined “zero gravity” position suitable for sleep. During movement from the elevated position to the reclined position, the rear portion of the seat cushion moves forward and down, while the front portion moves forward but remains at approximately the same elevation. The seat back may maintain the same orientation relative to the seat cushion such that both reach a significantly reclined position.

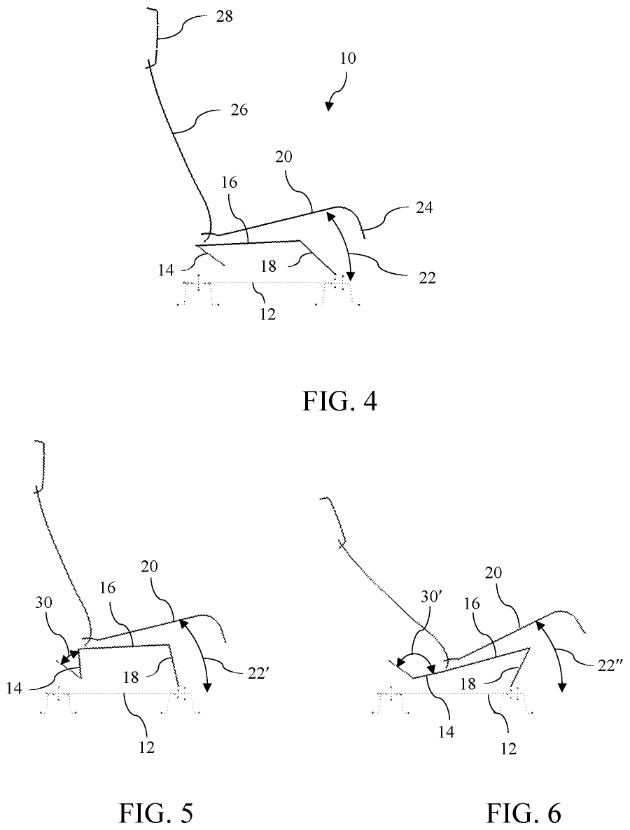

FIGS. 4-6 show the vehicle seat 10 in a stick-frame representation. The seat adjustment mechanism consists of four segments: fixed seat frame 12, rear rod 14, cushion frame 16, and front rod 18. The fixed seat frame 12 is adapted to be fixed to vehicle structure. Rear rod 14 and front rod 18 pivot with respect to fixed points on the fixed seat frame 12 and also with respect to pivot points on movable cushion frame 16. The distances between the four pivot points are effectively constant (subject to slight nutating movement described below with respect to some embodiments). The angular position of rear rod 14 with respect to fixed frame 12 is controlled by a motor-driven adjustment mechanism as will be described in more detail below.

FIG. 4 shows the elements in the base position of FIG. 1. Other seat components shown in FIGS. 4-6 are positioned relative to movable cushion frame 16. Seat cushion 20 has a fixed position relative to cushion frame 16. In the base position of FIG. 4, the angle 22 between the seat cushion and the fixed seat frame 12 is approximately 18 degrees. Leg cushion 24 and back rest 26 move with cushion frame 16, but the angles between these components may be adjustable via separate motor-driven or manual adjustment mechanisms. Similarly, head rest 28 moves with back rest 26. The angle between the back rest and the head rest may be adjustable via a separate motor-driven or manual adjustment mechanism. In some embodiments, the various adjustment mechanisms may be mechanically linked for coordinated movement or may have their movement coordinated via a common controller.

FIG. 5 shows the elements in the elevated position of FIG. 2. To reach this position from the base position, rear rod 14 is rotated through an angle 30 of approximately 49 degrees. In other embodiments, the rear rod may be rotated between 45 and 55 degrees during this transition. The angle 22′ between the seat cushion and the fixed frame is identical to the corresponding angle in the base position-approximately 18 degrees. The orientation of the cushion frame 16 is identical to the base position. However, the cushion frame 16, seat cushion 20, and attached components have translated forward and upward relative to the base position. At intermediate positions between the base position and the elevated position, the orientation of the cushion frame 16 is effectively constant, preferably varying by no more than five degrees.

FIG. 6 shows the elements in the reclined position of FIG. 3. To reach this position, rear rod 14 is rotated through an angle 30′ of approximately 132 degrees from the base position (83 degrees from the elevated position). In other embodiments, the rear rod may be rotated more than 120 degrees during the transition from the base position to the reclined position and between 75 and 90 degrees during the transition from the elevated position to the reclined position. The angle 22″ between the seat cushion and the fixed frame is approximately 30 degrees, or 12 degrees different than base and elevated positions. In other embodiments, the change in orientation may be at least 8 degrees and preferably more than ten degrees. During the transition from the elevated position to the reclined position, the rear portion of cushion frame 16 and cushion 20 is lowered. The front portion of cushion frame 16 and cushion 20 translates forward while remaining at approximately the same height.

The ability to provide height adjustment and a transition to a reclined position with a single actuator is enabled by several features. The rear rod is shorter than the front rod. In the base position, the rear rod and front rod are both oriented at an obtuse angle relative to the seat frame. In the elevated position, the rear rod is nearly perpendicular to the seat frame, but the front rod remains at an obtuse angle relative to seat frame. The rear rod is shorter, but rotates through a greater angle than the front rod. The net effect is that the vertical change in the positions of the front and rear pivot points of the seat frame is the same, so the orientation of the seat frame is the same in these two positions. While transitioning from the elevated position to the reclined position, the rear rod moves from nearly perpendicular to the seat frame to a sharp acute angle. Therefore, the rear pivot point of the seat frame moves downwardly, closer to the seat frame. The front rod, on the other hand, transitions from a slightly obtuse angle to a slightly acute angle, with little appreciable vertical movement.

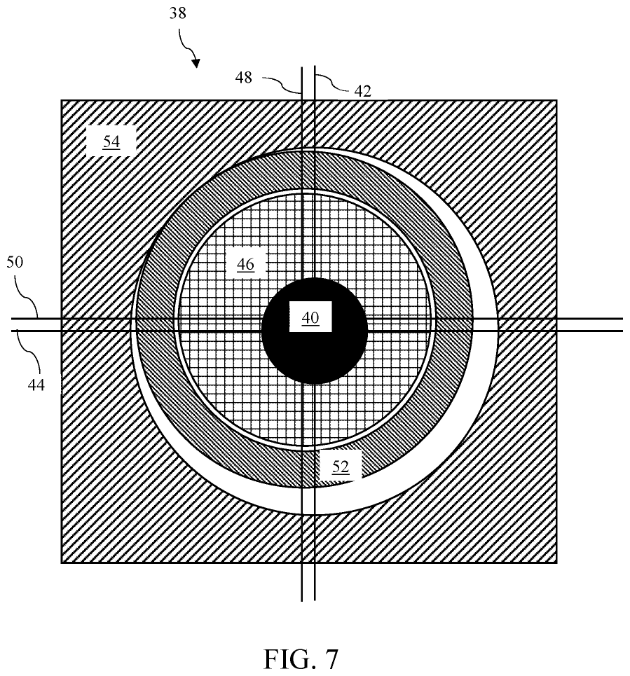

A single motor-driven actuator provides the elevation adjustment and the zero-gravity recline functionality. The angular travel associated with this adjustment is substantially longer than for most types of adjustable seat actuators. The actuator must be able to withstand high loads during a collision. A mechanism 38 based on eccentric gearing as depicted in FIG. 7 may be suitable for this application. A motor drives a shaft 40, potentially via a non-backdrivable reduction gear mechanism. Shaft 40 rotates about a first axis at the intersection of lines 42 and 44. Eccentric member 46 is rigidly attached to the shaft 40 for rotation therewith. Eccentric member 46 defines a second axis at the intersection of lines 48 and 50. When shaft 40 rotates, the second axis translates in a circular motion around the first axis. Inner ring gear 52 is supported by eccentric member 46 via a bearing such as a bushing. Therefore, inner ring gear 52 may rotate about the second axis as the second axis translates around the first axis. Inner ring gear 52 has Nᵢ external gear teeth (not shown) on its outer circumference. Outer ring 54 has Nₒ internal gear teeth (not shown) centered on the first axis. The pitch of the internal gear teeth and the external gear teeth are identical. Outer ring 54 has at least one more gear tooth than inner ring 52. As shaft 40 rotates clockwise, inner ring gear 52 has a small diameter translating movement (called planetary motion) and a counter-clockwise rotational movement with respect to outer ring 54.

In a first embodiment, the eccentric mechanism of FIG. 7 may be utilized in the adjustable vehicle seat 10 of FIGS. 1-6 by fixing the outer ring 54 to the fixed seat frame 12 and fixing the inner ring 52 to rear rod 14. Thus, rear rod 14 is pivotably attached to the fixed seat frame 12 via the eccentric mechanism. For purposes of this document, pivotably attached should be interpreted to encompass a connection that is predominantly rotational. The term pivotably attached encompasses a connection that is subject to a small degree of translation such as the planetary motion discussed above. The large number of gear teeth in contact at all times helps the mechanism withstand forces of a vehicle collision. The non-backdrivable characteristics of this type of mechanism makes the mechanism less dependent on non-backdrivable gearing between the motor and shaft 40 to stay in position.

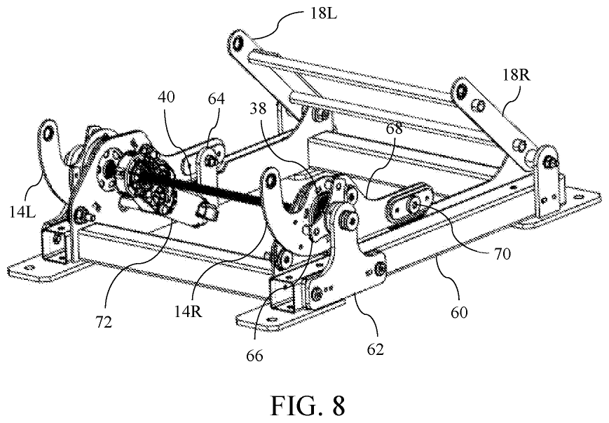

Although the planetary motion may be acceptable due to its small amplitude, it is desirable to have pure rotational movement between the rear rod 14 and the fixed seat frame 12. Elimination of the planetary motion may be more important in a long travel application because a greater speed of movement may be needed. A second embodiment, pictured in FIG. 8, achieves this. For clarity, only the components of the fixed frame 12, the rear rod 14, and the actuator are pictured. The underlying four-bar linkage is duplicated on the left and the right side of the seat. Therefore, two rear rods 14L and 14R and two front rods 18L and 18R are shown in FIG. 8. Many other components have mirror image counterparts on the opposite side. Fixed seat frame 12 includes tubes 60 and several brackets fixed thereto such as 62 and 64. Link arm 66 is supported via bracket 62 to rotate about an axis that is fixed with respect to the fixed frame 12. Rear rod 14 is rigidly attached to link arm 66 such that it also rotates about the fixed axis. Compensator 68 is supported by the fixed frame 12 in a manner that permits a limited degree of translation within a plane perpendicular to the axis. Compensator 68 includes a slider 70 that slides within a track in bracket 64, thus restricting rotation of compensator 68. Compensator 68 is fixed to the outer ring of eccentric mechanism 38. Rear rod 14 is fixed to the inner ring of eccentric mechanism 38. Motor 72 drives shaft 40. Motor 72 is supported by compensator 68. When motor 72 rotates shaft 40, rear rod 14 pivots about fixed seat frame 12 without translation. The planetary motion is accommodated by compensator 68.

Aspect 1. A vehicle seat includes a seat frame and a cushion frame connected by and rear and front rods. The seat frame is adapted for attachment to a vehicle. The seat frame and cushion frame each have a rear pivot point and a forward pivot point. The cushion frame supports a cushion. The rear rod is pivotably attached to the rear pivot point of the seat frame and pivotably attached to the rear pivot point of the cushion frame. The front rod is pivotably attached to the forward pivot point of the seat frame and pivotably attached to the forward pivot point of the cushion frame. A length of the rear rod, measured between the rear pivot point of the seat frame and the rear pivot point of the cushion frame, is less than a length of the front rod, measured between the forward pivot point of the seat frame and the forward pivot point of the cushion frame. In a base position, an angle between the forward pivot point of the seat frame, the rear pivot point of the seat frame, and the rear pivot point of the cushion frame is greater than ninety degrees. In a reclined position, the angle between the forward pivot point of the seat frame, the rear pivot point of the seat frame, and the rear pivot point of the cushion frame is less than ninety degrees.

Aspect 2. The vehicle seat of aspect 1, wherein an angle between the cushion frame and the seat frame is at least eight degrees greater in the reclined position than in the base position.

Aspect 3. The vehicle seat of aspect 2, wherein the angle between the cushion frame and the seat frame is at least ten degrees greater in the reclined position than in the base position.

Aspect 4. The vehicle seat of aspect 3, wherein the angle between the cushion frame and the seat frame is at least twelve degrees greater in the reclined position than in the base position.

Aspect 5. The vehicle seat of any of aspects 1 to 4, wherein, in an elevated position, the angle between the forward pivot point of the seat frame, the rear pivot point of the seat frame, and the rear pivot point of the cushion frame is between the corresponding angles in the base position and in the reclined position. An angle between the cushion frame and the seat frame in the elevated position is equal to the corresponding angle in the base position. The cushion frame is farther from the seat frame in the elevated position than in the base position.

Aspect 6. The vehicle seat of aspect 5, wherein, at all positions between the base position and the elevated position, the angle between the cushion frame and the seat frame is within five degrees of the corresponding angle in the base position.

Aspect 7. The vehicle seat of aspect 6 wherein the angle between the forward pivot point of the seat frame, the rear pivot point of the seat frame, and the rear pivot point of the cushion changes by between forty five and fifty five degrees while transitioning from the base position to the elevated position.

Aspect 8. The vehicle seat any of aspects 5 to 7, wherein the angle between the forward pivot point of the seat frame, the rear pivot point of the seat frame, and the rear pivot point of the cushion changes by between seventy five and ninety degrees while transitioning from the elevated position to the reclined position.

Aspect 9. The vehicle seat of any of aspects 1 to 8, wherein the angle between the forward pivot point of the seat frame, the rear pivot point of the seat frame, and the rear pivot point of the cushion changes by more than 120 degrees while transitioning from the base position to the reclined position.

Aspect 10. The vehicle seat of any of aspects 1 to 9, wherein the rear pivot point of the cushion is closer to the seat frame in the reclined position than in the base position.

Aspect 11. The vehicle seat of any of aspects 1 to 10, wherein the rear rod comprises a left rear rod and a right rear rod pivotably attached on opposing sides of the seat frame and the cushion frame.

Aspect 12. The vehicle seat of any of aspects 1 to 11, wherein the front rod comprises a left front rod and a right front rod pivotably attached on opposing sides of the seat frame and the cushion frame.

Aspect 13. The vehicle seat of any of aspects 1 to 12, further comprising an eccentric gearing mechanism pivotably attaching the seat frame to the rear rod, the eccentric gearing mechanism comprising an eccentric, an inner ring, and an outer ring, and wherein the angle between the forward pivot point of the seat frame, the rear pivot point of the seat frame, and the rear pivot point of the cushion is adjusted by rotating the eccentric.

Aspect 14. The vehicle seat of aspect 13 further comprising a compensator that translates with respect to the seat frame to counteracting translation of the eccentric such that a distance between the rear pivot point of the seat frame and the rear pivot point of the cushion frame remains constant as the rear rod rotates with respect to the seat frame.

Aspect 15. A vehicle seat having a seat frame and a cushion frame connected by rear and front rods. The seat frame is adapted for attachment to a vehicle. The cushion frame supports a cushion. The cushion frame has a rear pivot point and a forward pivot point. The rear rod is pivotably attached to the seat frame and pivotably attached to the cushion frame at the rear pivot point. The front rod is pivotably attached to the seat frame and pivotably attached to the cushion frame at the forward pivot point. Rotation of the rear rod about the rear pivot point moves the cushion frame from a base position, through an elevated position, to a reclined position. In the elevated position, the cushion frame is farther from the seat frame than in the base position and an angle between the cushion frame and the seat frame is the same as in the base position. In the reclined position, the rear pivot point is closer to the front rod than in the elevated position and the angle between the cushion frame and the seat frame is at least ten degrees greater than in the elevated position.

Aspect 16. The vehicle seat of aspect 15 wherein an angle between the rear rod and the seat frame changes by between forty five and fifty five degrees while transitioning from the base position to the elevated position.

Aspect 17. The vehicle seat of one of aspects 15 and 16, wherein an angle between the rear rod and the seat frame changes by between seventy five and ninety degrees while transitioning from the elevated position to the reclined position.

Aspect 18. A vehicle seat has a seat frame and a cushion frame connected by rear and front rods. The seat frame is adapted for fixation to a vehicle. The rear rod is pivotably attached to a rear pivot point of the seat frame and to a rear pivot point of the cushion frame. The front rod is pivotably attached to a forward pivot point of the seat frame and to a forward pivot point of the cushion frame. An eccentric gearing mechanism rotates the rear rod with respect to the seat frame. A compensator translates with respect to the seat frame counteracting translation of the eccentric such that a distance between the rear pivot point of the seat frame and the rear pivot point of the cushion frame remains constant as the rear rod rotates.

Aspect 19. The vehicle seat of aspect 18 wherein the eccentric gearing mechanism comprises an eccentric, an inner ring, and an outer ring.

Aspect 20. The vehicle of aspect 19 wherein the eccentric is driven by a motor, the inner ring is fixed to the rear rod, and the outer ring is fixed to the compensator.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A vehicle seat comprising:
a seat frame adapted for attachment to a vehicle, the seat frame comprising a rear pivot point and a forward pivot point;
a cushion frame to support a cushion, the cushion frame comprising a rear pivot point and a forward pivot point;
a rear rod pivotably attached to the rear pivot point of the seat frame and pivotably attached to the rear pivot point of the cushion frame; and
a front rod pivotably attached to the forward pivot point of the seat frame and pivotably attached to the forward pivot point of the cushion frame, wherein:
a length of the rear rod, measured between the rear pivot point of the seat frame and the rear pivot point of the cushion frame, is less than a length of the front rod, measured between the forward pivot point of the seat frame and the forward pivot point of the cushion frame;
in a base position, an angle between the forward pivot point of the seat frame, the rear pivot point of the seat frame, and the rear pivot point of the cushion frame is greater than ninety degrees; and
in a reclined position, the angle between the forward pivot point of the seat frame, the rear pivot point of the seat frame, and the rear pivot point of the cushion frame is less than ninety degrees.

2. The vehicle seat of claim 1, wherein an angle between the cushion frame and the seat frame is at least eight degrees greater in the reclined position than in the base position.

3. The vehicle seat of claim 2, wherein the angle between the cushion frame and the seat frame is at least ten degrees greater in the reclined position than in the base position.

4. The vehicle seat of claim 3, wherein the angle between the cushion frame and the seat frame is at least twelve degrees greater in the reclined position than in the base position.

5. The vehicle seat of claim 1, wherein, in an elevated position:
the angle between the forward pivot point of the seat frame, the rear pivot point of the seat frame, and the rear pivot point of the cushion frame is between the corresponding angles in the base position and in the reclined position;
an angle between the cushion frame and the seat frame is equal to the corresponding angle in the base position; and
the cushion frame is farther from the seat frame than in the base position.

6. The vehicle seat of claim 5, wherein, at all positions between the base position and the elevated position, the angle between the cushion frame and the seat frame is within five degrees of the corresponding angle in the base position.

7. The vehicle seat of claim 6 wherein the angle between the forward pivot point of the seat frame, the rear pivot point of the seat frame, and the rear pivot point of the cushion changes by between forty five and fifty five degrees while transitioning from the base position to the elevated position.

8. The vehicle seat of claim 5 wherein the angle between the forward pivot point of the seat frame, the rear pivot point of the seat frame, and the rear pivot point of the cushion changes by between seventy five and ninety degrees while transitioning from the elevated position to the reclined position.

9. The vehicle seat of claim 1 wherein the angle between the forward pivot point of the seat frame, the rear pivot point of the seat frame, and the rear pivot point of the cushion changes by more than 120 degrees while transitioning from the base position to the reclined position.

10. The vehicle seat of claim 1 wherein the rear pivot point of the cushion is closer to the seat frame in the reclined position than in the base position.

11. The vehicle seat of claim 1 wherein the rear rod comprises a left rear rod and a right rear rod pivotably attached on opposing sides of the seat frame and the cushion frame.

12. The vehicle seat of claim 1 wherein the front rod comprises a left front rod and a right front rod pivotably attached on opposing sides of the seat frame and the cushion frame.

13. The vehicle seat of claim 1 further comprising an eccentric gearing mechanism pivotably attaching the seat frame to the rear rod, the eccentric gearing mechanism comprising an eccentric, an inner ring, and an outer ring, and wherein the angle between the forward pivot point of the seat frame, the rear pivot point of the seat frame, and the rear pivot point of the cushion is adjusted by rotating the eccentric.

14. The vehicle seat of claim 13 further comprising a compensator that translates with respect to the seat frame to counteracting translation of the eccentric such that a distance between the rear pivot point of the seat frame and the rear pivot point of the cushion frame remains constant as the rear rod rotates with respect to the seat frame.

15. A vehicle seat comprising:
a seat frame adapted for attachment to a vehicle;
a cushion frame supporting a cushion, the cushion frame comprising a rear pivot point and a forward pivot point;
a rear rod pivotably attached to the seat frame and pivotably attached to the cushion frame at the rear pivot point; and
a front rod pivotably attached to the seat frame and pivotably attached to the cushion frame at the forward pivot point, wherein:
rotation of the rear rod about the rear pivot point moves the cushion frame from a base position, through an elevated position, to a reclined position;
in the elevated position, the cushion frame is farther from the seat frame than in the base position and an angle between the cushion frame and the seat frame is the same as in the base position; and
in the reclined position, the rear pivot point is closer to the front rod than in the elevated position and the angle between the cushion frame and the seat frame is at least ten degrees greater than in the elevated position.

16. The vehicle seat of claim 15 wherein an angle between the rear rod and the seat frame changes by between forty five and fifty five degrees while transitioning from the base position to the elevated position.

17. The vehicle seat of claim 15 wherein an angle between the rear rod and the seat frame changes by between seventy five and ninety degrees while transitioning from the elevated position to the reclined position.

18. A vehicle seat comprising:
a seat frame adapted for fixation to a vehicle;
a cushion frame;
a rear rod pivotably attached to a rear pivot point of the seat frame and to a rear pivot point of the cushion frame;
a front rod pivotably attached to a forward pivot point of the seat frame and to a forward pivot point of the cushion frame;
an eccentric gearing mechanism rotating the rear rod with respect to the seat frame; and
a compensator that translates with respect to the seat frame counteracting translation of the eccentric such that a distance between the rear pivot point of the seat frame and the rear pivot point of the cushion frame remains constant as the rear rod rotates.

19. The vehicle seat of claim 18 wherein the eccentric gearing mechanism comprises an eccentric, an inner ring, and an outer ring.

20. The vehicle of claim 19 wherein the eccentric is driven by a motor, the inner ring is fixed to the rear rod, and the outer ring is fixed to the compensator.
